(19) United States
(12) Patent Application Publication
(10) Pub. No.: US 2013/0257189 A1
(43) Pub. Date: Oct. 3, 2013

(54) BALANCED ROTOR FOR A ROTATION MACHINE, AND METHOD FOR BALANCING A ROTOR

(71) Applicants: Steffen Blum, Sulzheim (DE); Stephan Weissphal, Bietigheim-Bissingen (DE); Markus Minnermann, Hannover (DE)

(72) Inventors: Steffen Blum, Sulzheim (DE); Stephan Weissphal, Bietigheim-Bissingen (DE); Markus Minnermann, Hannover (DE)

(21) Appl. No.: 13/876,956

(22) PCT Filed: Jul. 28, 2011
(86) PCT No.: PCT/EP2011/063014

§ 371 Date: Jun. 21, 2013

(30) Foreign Application Priority Data
Sep. 29, 2010 (DE) 102010041599.5

(51) Int. Cl. H02K 7/04; H02K 15/16

(52) U.S. Cl. CPC H02K 7/04; H02K 15/165
USPC 310/51; 29/598

(57) ABSTRACT

A balanced rotor and a method for balancing a rotor for a rotation machine are described, such as an electric motor. The rotor has at least one disk-shaped rotor body which has magnet elements in the region of an outer periphery. Furthermore, a plurality of recesses is formed outside the center in the rotor body. To balance the rotor body, a rivet such as in the form of a blind rivet or a Rivscrew® rivet, may be introduced and press-fit in one recess or in a plurality of these recesses. The rivet is introduced directly into the rotor body. An additional balancing ring disk may be dispensed with. This allows simple, cost-effective and reliable balancing of the rotor.

### FIELD

The present invention relates to a balanced rotor for a rotation machine. In addition, the present invention relates to a method for balancing a rotor for a rotation machine.

### BACKGROUND INFORMATION

Rotating bodies, such as rotors of rotation machines, should be balanced prior to being taken into operation, especially if they are to be operated at high rotational speeds. Well balanced rotors may play an important part in a long service life of bearings and shafts and also in the radiation of sound and the transmission of vibrations to the environment.

Rigid rotors are usually able to be balanced by adding or removing masses at a certain distance from the axis of rotation in one or more plane(s) situated perpendicularly to an axis of rotation of the rotor. In this context it may be distinguished between a static imbalance and a dynamic imbalance. In a static imbalance the center of mass of the rotor does not lie on the axis of rotation. In the ideal case, a static imbalance may be eliminated using only one balancing mass. In the case of dynamic imbalances, also referred to as moment imbalances, the center of mass of the rotor does lie on the axis of rotation, but the main axis of inertia does not run parallel to the axis of rotation. Balancing in such a case usually requires a plurality of balancing masses, which must be distributed among at least two planes, so that the main axis of inertia of the rotor, including the balancing masses, is rotated in such a way that it subsequently lies on the axis of rotation.

Generally, rotatable bodies, such as rotors for fast running rotation machines, are balanced by the placement of additional balancing ring disks. The balancing ring disks are frequently situated at the two opposite-lying end faces of the rotor and rotate along with the rotor when the rotor is in operation. In the case of so-called additive balancing, it is possible to attach lead weights to the balancing ring disk in order to thereby allow an imbalance of the rotor to be compensated. As an alternative, bore holes may be introduced into the balancing ring disk rotating along, which causes a shift in the center of mass of the disk rotating along and once again makes it possible to compensate for an imbalance of the rotor. This is referred to as subtractive balancing.

### SUMMARY

There may be a demand for a balanced rotor or for a method for balancing a rotor, in which balancing is able to be achieved with less work and expense.

A balanced rotor for a rotation machine is described according to a first aspect of the present invention. The balanced rotor has at least one disk-shaped rotor body which includes magnet elements along a periphery of the rotor body. A plurality of recesses is formed outside the center in the rotor body and a rivet is introduced and press-fit in at least one of these recesses.

In a second aspect of the present invention, a method for balancing a rotor for a rotation machine is described. The method includes providing the rotor, which has at least one disk-shaped rotor body with magnet elements along a periphery of the rotor body and a plurality of recesses located outside the center in the rotor body; determining an imbalance of the rotor, and subsequently press-fitting at least one rivet in one of the recesses, located outside the center such that an imbalance of the rotor is compensated at least partially.

Conventionally, balanced rotors for rotation machines frequently have a separate balancing ring disk on at least one end face of the rotor, or often on both end faces, in addition to the actual rotor which carries the magnets required for driving the rotor in motor mode or generator mode within the rotation machine. Weights or recesses are able to be introduced into this balancing ring disk in order to balance the overall unit composed of rotor and balancing ring disk. Since this balancing ring disk is a separate, additional component, its inclusion entails additional work and expense. Furthermore, the additional balancing ring disk has a mass that contributes to a higher inertia moment of the entire rotating component, inasmuch as it must rotate along with the rotor. In conventional additive balancing, in which a single pin or several pins is/are pressed into a separate balancing ring disk provided with corresponding holes, it may additionally be necessary to produce the balancing ring disk from a material that is able to ensure that the prestress at which the pins are held in the holes of the balancing ring disk is maintained to a sufficient degree.

In contrast thereto, if possible, separate balance ring disks should be dispensed with in the balanced rotor introduced here.

Toward this end, the frequently disk-shaped rotor bodies which form the rotor are designed accordingly, in such a way that it is possible to place supplementary weights directly inside them for balancing purposes. For example, the rotor bodies may be formed in the shape of a disk or have an outer geometry that is not disk-shaped, such as the shape of a polygonal, flower etc. Such a disk-shaped rotor body is normally provided with magnet elements along its periphery, e.g., permanent magnets or electromagnets, so that a magnetic field acting from the outside is able to exert a torque on the rotor body during motoric operation and thereby induce the rotor to execute rotary motions, or so that, in generator operation, a magnetic field that varies when the rotor is rotating is able to generate a voltage in surrounding coils. For example, the magnet elements may be fixed in place along the periphery of the rotor body on its lateral surface, using suitable methods such as bonding, for instance. As an alternative, the magnet elements may also be situated within the rotor body in so-called buried manner, for which purpose cavities are then provided in the rotor body, near the outer periphery, into which the magnet elements are able to be inserted and where they are held in place. A rotor having a single disk-shaped rotor body is basically able to be formed, but in practice, rotors often include a plurality of disk-shaped rotor bodies, the individual rotor bodies frequently being situated next to each other on a shaft along an axis of rotation, and press-fit with the shaft.

In addition to the magnet elements, recesses are formed outside the center in the rotor body in the rotor described here. These recesses outside the center are radially situated at a distance from the axis of rotation of the rotor body. Their purpose is to accommodate additional mass in order to thereby allow the center of mass of the rotation body to be shifted and to provide balancing of the rotor body in this manner. In order to be able to compensate for different types and dimensions of imbalances, a plurality of recesses outside the center is provided. For example, eight or more, preferably 16 or more, recesses may be present outside the center. The recesses are able to be developed along a circle which extends concentrically with the rotor body. In other words, the radial clearance of all recesses with respect to the axis of rotation of the rotor body may be equal. The recesses may be disposed along the concentric circle in equidistant fashion. Preferably, the recesses are situated in the rotor body and dimensioned in such a way that their joint center of mass lies on the axis of rotation of the rotor body.

A rivet is disposed in at least one of the recesses provided in the rotor body or the plurality of rotor bodies in the balanced rotor. A rivet is a plastically deformable, essentially cylindrical element. Rivet joints conventionally are often used to join parts such as sheet metal, and are standard components available in large quantities and thus are able to be produced at low cost.

Rivets are available in a multitude of materials and developments. For example, there are rivets made of steel, copper, brass, aluminum alloys, plastic and titanium. Solid rivets, blind rivets, punch rivets, semitubular rivets, etc. are conventional.

Components into which the rivet is to be introduced and joined thereto by pressfitting, or components which are to be connected to each other with the aid of rivets must have recesses such as in the form of bore holes, for example. These recesses should have a diameter that is slightly larger than the rivet. The rivet is slipped into or through these recesses. In so doing, the rivet may project beyond a surface of the component. The rivet may be worked in such a way that a projecting end of the rivet is formed into a so-called buck-tail, which rests against surfaces of the component and thus retains the rivet on the component. As an alternative, the rivet may be worked in such a way that its shaft disposed in the recess grows thicker, i.e., is enlarged in its diameter, so that an outer circumference of the rivet shaft is press-fit against an inner circumference of the recess and the rivet is press-fit in the recess as a result.

Rivets may have an advantage over screws in that no thread needs to be provided in the recesses in the component. In addition, the rivet is often introduced and fastened in rapid and uncomplicated manner. The rivet may initially have a smaller cross-section than the recess and therefore be introduced into the recess very easily. Suitable tools may then be used to spread the rivet inside the recess and thereby fasten it by enlarging its cross-section. In the fastened state, the rivet is pressed into the recess in force-locking and/or form-fitting manner.

By introducing and press-fitting the rivet in the recess provided in the rotor body itself, the rivet is able to be fastened in the rotor body in reliable manner. Since the rivet has weight on its own, which is accommodated in the recess lying outside the center and may lead to an additional moment when the rotor is rotating, balancing of the entire rotor is able to be achieved with the aid of the press-fit rivet. With regard to their positions and to their form, the recesses in the rotor body are preferably situated and developed in such a way, and the form and weight of the at least one rivet situated in at least one of the recesses are developed in such a way that an imbalance of the totality of rotor body and rivet is less than an imbalance of the rotor body by itself. In other words, an imbalance of the rotor body is able to be reduced as a result of the rivet press-fit inside the recess, and the form, position and weight of the rivet are adaptable to the imbalance to be compensated.

To balance the rotor, for example, an imbalance of the rotor without the rivet may be determined to begin with, using measuring technology or empirical values. Based on the determined imbalance, it may then be analyzed in which way an appropriate counter-imbalance can be produced in that rivets having the appropriate weight are press-fit in recesses within the rotor at suitable locations. In this way it is possible to achieve balancing of the rotor at a balancing quality of G 2.5 or even G 1. The balancing quality can be defined according to the ISO 1940 standard.

Rivets to be introduced in the recesses may be blind rivets. A blind rivet is a special form of rivet, which requires access to only one side of the component to be provided with the rivet. Special blind rivet pliers may be used to fasten the blind rivet. Typically, the blind rivet includes the actual hollow rivet body featuring a head on the front side, and a longer elongated pin which features a head on the rear rivet end and has a rupture joint. So-called magazine rivets have no separate pin, but the pin is integrated in the tool that may be used to fasten the blind rivet. Blind rivets are sometimes also called POP rivets. No additional head is required at the rear end.

When riveting blind rivets, a joining operation or press-fitting operation is carried out only from one side, the outer side of the component. The blind rivet is inserted into the recess. The pin projecting at the head then is pulled out with the aid of blind rivet pliers. This results in compression and thus in spreading of the rivet, i.e., an enlargement of the diameter of the rivet, inside the recess. At the end of the procedure, the pin typically ruptures at the rupture joint inside the rivet body and no longer projects from the rivet. Blind rivets are produced for all kinds of purposes and thus are standard components manufactured in large batches, which are able to be supplied in very cost-efficient manner. The use of blind rivets for balancing a rotor therefore constitutes a very cost-effective balancing method.

Rotor bodies for rapidly rotating rotors of permanently excited synchronous machines, as they are used for electric-drive and hybrid-drive vehicles, for example, are often developed from a plurality of concentrically stacked lamellar sheets. To form a rotor lamination, multiple thin sheets are stacked and joined in a press-fitting operation, for example. The individual sheets may be shaped very easily by die-cutting. As described here earlier, for example, the recesses into which the buried magnets are insertable, or the recesses that are to accommodate the balancing rivet, are able to be produced by punching out suitable areas from the lamellar sheet. Since certain geometric deviations caused by production tolerances invariably arise when punching out the recesses, a certain offset of the recesses punched into the individual lamellar sheets is frequently encountered in the recesses for the balancing rivet formed in the stacked rotor lamination. This leads to an uneven, e.g., tooth-shaped, structure at the surface of the recesses, in a direction parallel to the axis of rotation of the rotor body.

A rivet likewise provided with an uneven surface may advantageously be inserted into such a recess having a non-planar surface. Because of the non-planar surface of both the recess and the rivet, a form-locking connection between rivet and recess is able to be created. This ensures excellent support of the rivet in the recess.

A rivet featuring a screw geometry is able to be used as a rivet having an especially uneven surface. Such rivets are also referred to as Rivscrew® rivets. In particular in the case of rotor bodies formed by rotor laminations, such screw-like rivets are able to engage with recesses within the rotor laminations likewise provided with an uneven surface in stable manner due to their “serrated” surface. Notwithstanding slightly higher manufacturing costs for such screw-type rivets in comparison with simple blind rivets, their use may be justified on account of their better hold characteristic.

The rivets are frequently made of a different material than that of the rotor body. In order not to interfere with the magnetic field generated by the magnet elements provided along the periphery of the rotor body, it may be advantageous to place the recesses into which the rivets are to be inserted at a distance of at least 5 mm, preferably at least 7 mm, from the magnet elements. The recesses in the rotor body may be situated radially within the magnet elements. A negative effect on the magnetic flux produced by the magnet elements is avoided due to the sufficient distance of the recesses from the magnet elements.

It should be noted that the present invention is described here in connection both with a balanced rotor system and a method for balancing a rotor for a rotation machine. The individually described features are combinable in various ways in order to result in other developments of the present invention as well.

### BRIEF DESCRIPTION OF THE DRAWINGS

Specific embodiments of the present invention are explained in greater detail below with reference to the figures.

FIG. 1 shows a cross-sectional view of a balanced rotor for a rotation machine according to one specific embodiment of the present invention.

FIG. 2 shows a cross-sectional view of a balanced rotor for a rotation machine according to another specific embodiment of the present invention.

FIG. 3 shows a plan view of a rotor body for a balanced rotor according to one specific embodiment of the present invention.

FIG. 4 shows an enlarged view of a recess for accommodating a rivet in a rotor body for a rotor according to one specific embodiment of the present invention.

The figures are only schematic and not drawn to scale.

### DETAILED DESCRIPTION OF EXAMPLE EMBODIMENTS

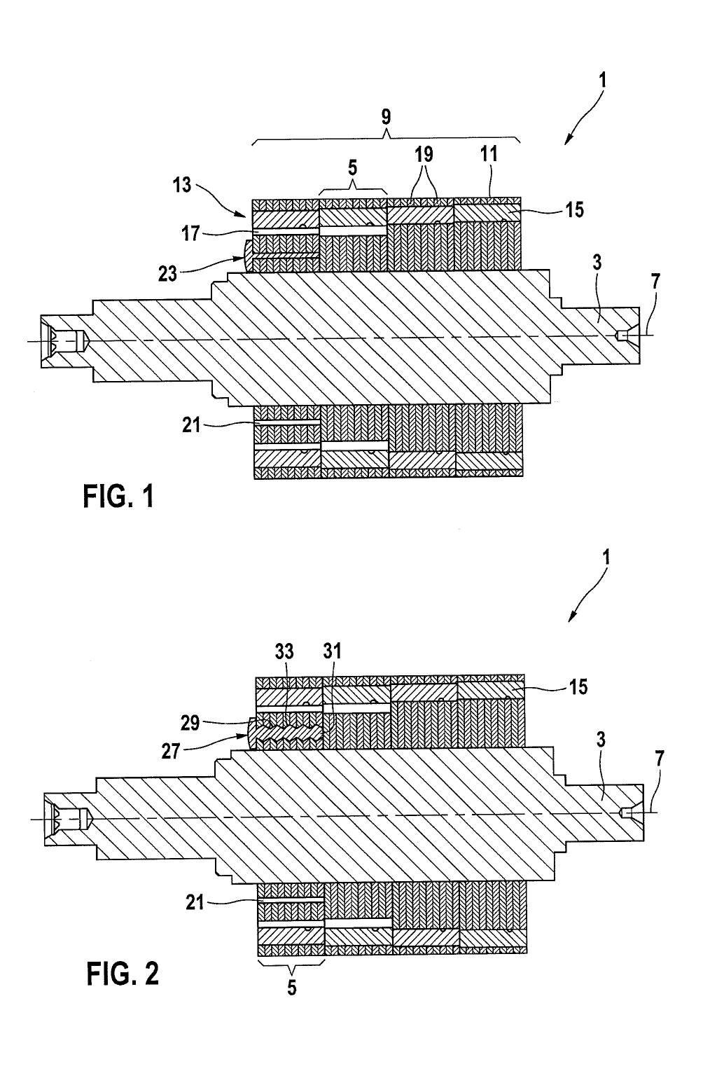

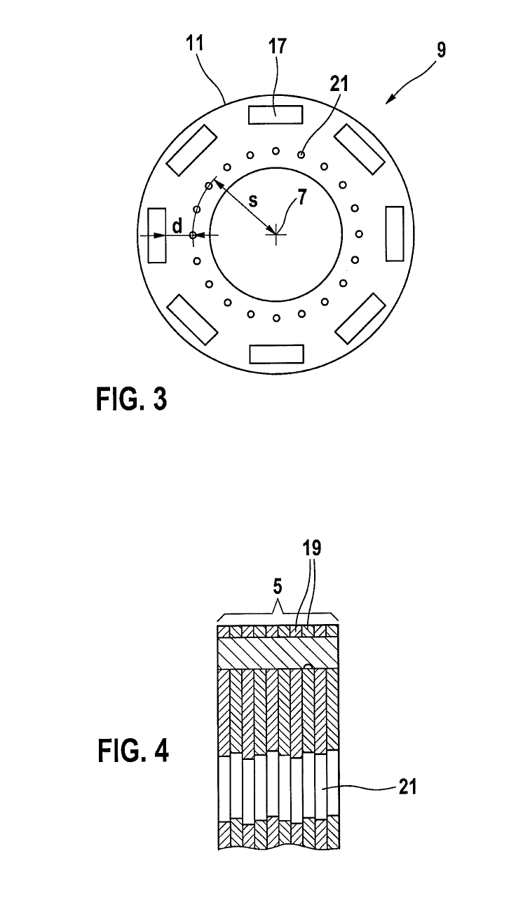

FIG. 1 shows a rotor 1 for a rotation machine such as an electric motor or a generator, for instance. A plurality of rotor laminations 5 is situated on a shaft 3, one after the other in a direction along an axis of rotation 7, and joined to shaft 3 by press-fitting. Each rotor lamination 5 is made up of a plurality of stacked lamellar sheets 19. The plurality of rotor laminations 5 jointly forms a disk-shaped rotor body 9. A plan view of an end face of rotor body 9 is shown in FIG. 3.

A plurality of magnet elements 13 in the form of rectangular permanent magnets 15 is situated near outer periphery 11 of rotor body 9. Magnet elements 13 are inserted into recesses 17 in rotor body 9, which are likewise implemented in rectangular form, and fixated there by means of press-fitting or bonding.

Moreover, a plurality of recesses 21 is provided in the outermost rotor lamination 5 of rotor body 9. Recesses 21 are situated at a specific distance s from the center of the rotor body through which axis of rotation 7 runs, and thus are positioned in off-centered manner. Moreover, recesses 21 are situated at a distance d from recesses 17 for the magnet elements.

In the example shown, rotor body 9 has an outer diameter of 83 mm. Distance s of recesses 21 from the center is 25 mm. Distance d of recesses 21 from recesses 17 is 7 mm. Twenty recesses 21 are situated in equidistant manner along a circle that is concentric with axis of rotation 7. Each recess 21 has a circular cross-section with a diameter in the range from 1 to 5 mm. A depth of recess 21 in a direction parallel to axis of rotation 7 may lie in the range of 5 to 20 mm.

Blind rivets 23 may be introduced into recesses 21 and press-fit therein. In a balancing operation, the imbalance of entire rotor 1 is determined to start with. Using the determined imbalance, it is possible to calculate at which positions counterweights should be introduced in rotor 1. Rivets of a suitable weight are then able to be press-fit in a corresponding recess 21 at these positions. The rivets may have weights in a range between 0.1 and 2 g, preferably in a range between 0.35 and 1.5 g.

In the specific embodiment shown in FIG. 1, the additive balancing weight is provided in the form of a blind rivet 23. The rivet is introduced into rotor lamination 5 situated at the left edge in the figure from the outside, and then press-fit once rotor laminations 5 have been mounted on shaft 3. The desired position of the balancing weight is determined with the aid of a balancing system. If the weight of a single rivet is insufficient, an additional rivet may be mounted at another location. A multitude of circular hole recesses 21 punched into rotor lamination 5 is available for this purpose. Blind rivets 23 of different weights may be used.

This method offers advantages stemming from the low cost of the balancing weights, since the blind rivets used for this purpose are standard components which are able to be produced in large numbers at low cost. In addition, the process of press-fitting the rivets is true and tested and reliable. It is a clean process, which from the outset excludes contamination of the rotor by shavings of balancing bores, for example, because recesses 21 are able to be formed already during the manufacturing process of rotor laminations 5, for instance by punching, and no longer need to be introduced after rotor laminations 5 have been assembled into an overall rotor.

In the specific embodiment shown in FIG. 2, special rivets 25 having an uneven surface 27 have been introduced in recesses 21 in rotor 1. So-called Rivscrews® rivets are used for this purpose. These Rivscrews® rivets have a screw thread 33 on a lateral surface of otherwise cylindrical shaft 31. As shown in FIG. 4 in an enlarged view, rotor laminations 5 have a multitude of individual lamellar sheets 19. Recesses 21 are stamped into individual lamellar sheets 19 before lamellar sheets 19 are joined to form rotor laminations 5. Due to manufacturing tolerances, slight deviations with regard to the position and size of the punched out areas frequently occur in the process. In the assembled rotor lamination 5, this manifests itself in a non-planar recess 21; instead, a serrated structure forms, caused by the unavoidable offset during punching. The serrated structure of the screw-like outer surface of Rivscrew® rivet 27 is able to engage well with the serrated structure of recess 21 and results in a form-fitting press-fit.

It is noted that despite the fact that the figures show only one rivet 23, 27 in each case, multiple rivets may be situated in rotor body 9. Although only one rivet in a rotor lamination 5 at the outermost left edge of rotor body 9 is shown, rivets could also be accommodated in a rotor lamination at the outermost right edge, or in rotor laminations 5 at both rotor laminations 5 situated at opposite-lying edges of rotor body 9.

With the aid of the described balanced rotor or the method for balancing a rotor, cost-effective yet precise balancing at a balancing quality of more than G2.5, for example, is able to be achieved.

1-10. (canceled)

11. A balanced rotor for a rotation machine, comprising:
at least one disk-shaped rotor body having magnet elements along a periphery of the rotor body;
wherein the rotor body has a plurality of recesses located outside a center of the rotor body, and a rivet is situated in at least one recess.

12. The rotor as recited in claim 11, wherein the recesses are situated and formed in such a way, and the at least one rivet disposed in at least one recess is developed in such a way that an imbalance of a totality made up of rotor body and rivet is smaller than an imbalance of the rotor body by itself.

13. The rotor as recited in claim 11, wherein the rivet is a blind rivet.

14. The rotor as recited in claim 11, wherein the rotor body includes a plurality of concentrically stacked lamellar sheets.

15. The rotor as recited in claim 11, wherein the rivet has a non-planar surface.

16. The rotor as recited in claim 11, wherein the rivet has the geometry of a screw.

17. The rotor as recited in claim 11, wherein the at least one rivet is press-fit in the recess in at least one of force-locking and form-fitting manner.

18. The rotor as recited in claim 11, wherein the recesses are situated along a circle which is formed concentrically with the rotor body.

19. The rotor as recited in claim 11, wherein the recesses are situated at a distance of at least 5 mm from the magnet elements.

20. A method for balancing a rotor for a rotation machine, comprising:
providing the rotor, which has at least one disk-shaped rotor body having magnet elements along a periphery of the rotor body and a plurality of recesses in the rotor body situated outside a center of the rotor body;
determining an imbalance of the rotor; and
press-fitting at least one rivet in one of the recesses located outside the center in such a way that an imbalance of the rotor is at least partially compensated.
